(19) United States
(12) Patent Application Publication
(10) Pub. No.: US 2020/0210170 A1
(43) Pub. Date: Jul. 2, 2020

(54) RESOLVING POTENTIAL MERGE CONFLICTS BY UTILIZING A DISTRIBUTED BLOCKCHAIN FRAMEWORK

(71) Applicant: HCL America Inc, Sunnyvale, CA (US)

(72) Inventor: Kyle Matthew Johnson, Raleigh, NC (US)

(21) Appl. No.: 16/233,205

(22) Filed: Dec. 27, 2018

(51) Int. Cl. G06F 8/71; G06F 16/11; G06F 16/17; G06F 16/18; G06F 16/182; H04L 29/08; H04L 9/06

(52) U.S. Cl. CPC G06F 8/71; G06F 16/113; G06F 16/17; H04L 2209/38; G06F 16/182; H04L 67/34; H04L 9/0637; G06F 16/1873

(57) ABSTRACT

Disclosed is a system for resolving merge conflict using a distributed blockchain framework including a set of computing nodes. A block of a code snippet, of a plurality of code snippets, is registered in a distributed blockchain framework. A subset of computing nodes comprising a copy of the code snippet is identified. A change set associated with the code snippet is sent to the subset of computing nodes. A conflict is determined between the change set and the copy of the code snippet stored at a computing node of the subset of computing nodes. An approval is received to push the change set into the code repository when the conflict is determined. The approval indicates that the conflict is resolved when the change set is executed locally by the computing node. The change set is pushed into the code repository indicating modification in the copy of code snippet.

### PRIORITY INFORMATION

This patent application does not claim priority from any application.

### TECHNICAL FIELD

The present subject matter described herein, in general, relates to a version control system present in software development environment using a distributed blockchain framework and more particularly to resolve merge conflict during software development using a distributed blockchain framework.

### BACKGROUND

In general, merge conflicts in a Version Control Systems (VCS) of a software development lifecycle become messy and complex. Further, the merge conflicts may be undemocratic in resolving. For example, in Git, if two people are actively developing the same section of a file, the second committer may encounter a merge conflict, and may not need input from the first developer when resolving. In the aforementioned example, developers may work autonomously in local workspace or branch, but the developer may develop over the same lines of code as another teammate without knowing, until after an identical code segment is pushed to a common repository. Thus, the merge conflicts become a challenging task to resolve.

One way to prevent merge conflicts in conventional file systems is by using file locking. In the conventional file system, a developer may claim exclusive write, or even read access to a file until the developer has finished editing. However, in a large development group, excluding every other developer from editing a file may cause significant blockers into another developer's workflow.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for resolving merge conflict using a distributed blockchain framework and the concepts are further described below in the detailed description. This summary is not intended to identify essential features of the claimed subject matter nor is it intended for use in determining or limiting the scope of the claimed subject matter.

In one implementation, a system for resolving merge conflict using a distributed blockchain framework is disclosed. The system may comprise a set of computing nodes corresponding to the distributed blockchain framework. Each computing node, of the set of computing nodes, may comprise a processor and a memory coupled to the processor. The processor may execute a set of instructions stored in the memory. Initially, the processor may be configured to register a block of a code snippet, from a plurality of code snippets, in a distributed blockchain framework. The code snippet may be a subset of a software code present in a code repository. In one aspect, the block may indicate an entry marked by at least one computing node into the distributed blockchain framework. Further to registering, the processor may be configured to identify a subset of computing nodes comprising a copy of the code snippet. Upon identifying the subset of computing nodes, the processor may send a change set associated with the code snippet to the subset of computing nodes. In one aspect, the change set may indicate modification in the code snippet programmed by the at least one computing node. Subsequently, the processor may determine a conflict between the change set and the copy of the code snippet stored at a computing node of the subset of computing nodes. Furthermore, the processor may receive an approval from the computing node to push the change set into the code repository when the conflict is determined. It is to be noted that the approval may indicate that the conflict is resolved when the change set is executed locally by the computing node. Subsequently, the processor is configured to push the change set into the code repository to indicate modification in the copy of code snippet stored locally in the subset of computing nodes.

In one implementation, a method for resolving merge conflict using a distributed blockchain framework including a set of computing nodes is disclosed. In order to resolve the merge conflict, initially, a block of a code snippet, of a plurality of code snippets, may be registered in a distributed blockchain framework. In one aspect, the code snippet may be a subset of a software code present in a code repository. In another aspect, the block may indicate an entry marked by at least one computing node into the distributed blockchain framework. Further, a subset of computing nodes comprising a copy of the code snippet may be identified from a set of computing nodes. Upon identifying the subset of computing nodes, a change set associated with the code snippet may be sent to the subset of computing nodes. The change set may indicate modification in the code snippet programmed by the at least one computing node. Further, a conflict may be determined between the change set and the copy of the code snippet stored at a computing node of the subset of computing nodes. Subsequently, an approval may be received from the computing node to push the change set into the code repository when the conflict is determined. In one aspect, the approval indicates that the conflict is resolved when the change set is executed locally by the computing node. Furthermore, the change set may be pushed into the code repository to indicate modification in the copy of code snippet stored locally in the subset of computing nodes. In another aspect, the aforementioned method for resolving merge conflict using a distributed blockchain framework including a set of computing nodes may be performed by each computing node comprising a processor using programmed instructions stored in a memory.

In yet another implementation, non-transitory computer readable medium embodying a program executable in a computing device for resolving merge conflict using a distributed blockchain framework including a set of computing nodes is disclosed. The program may comprise a program code for registering a block of a code snippet, of a plurality of code snippets, in a distributed blockchain framework. The code snippet may be a subset of a software code present in a code repository. The block may indicate an entry marked by at least one computing node into the distributed blockchain framework. The program may further comprise a program code for identifying a subset of computing nodes comprising a copy of the code snippet. The program may further comprise a program code for sending a change set associated with the code snippet to the subset of computing nodes. The change set indicates modification in the code snippet programmed by the at least one computing node. The program may further comprise a program code for determining a conflict between the change set and the copy of the code snippet stored at a computing node of the subset of computing nodes. The program may further comprise a program code for receiving an approval from the computing node to push the change set into the code repository. The approval may indicate that the conflict is resolved when the change set is executed locally by the computing node. The program may further comprise a program code for pushing the change set into the code repository to indicate modification in the copy of code snippet stored locally in the subset of computing nodes.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a Peer-to-Peer (P2P) network implementation of a system for resolving merge conflict using a distributed blockchain framework including a set of computing nodes, in accordance with an embodiment of the present subject matter.

FIG. 2 illustrates a computing node, in accordance with an embodiment of the present subject matter.

FIG. 3 illustrates an example of the system comprising 5 computing nodes, in accordance with an embodiment of the present subject matter.

FIG. 4 and FIG. 5 illustrate blockchain with one or more blocks pertaining to each computing node, in accordance with an embodiment of the present subject matter.

FIG. 6 illustrates an example negotiation between one or more computing nodes, in accordance with an embodiment of the present subject matter.

FIG. 7 illustrates blockchain post pushing the change set to the code repository, in accordance with an embodiment of the present subject matter.

FIG. 8 illustrates an implementation of a central database in the system, in accordance with an embodiment of the present subject matter.

FIG. 9 illustrates a method for resolving merge conflict using a distributed blockchain framework including a set of computing nodes, in accordance with an embodiment of the present subject matter.

### DETAILED DESCRIPTION

Some embodiments of this disclosure, illustrating all its features, will now be discussed in detail. The words “comprising,” “including,” and “having,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present invention facilitates resolution of merge conflicts between two or more developers working in a software development environment based on a distributed blockchain framework. It is to be noted that a software code may comprise of a set of code snippets. In an implementation a team of developers may be working on one or more code snippets from the set of code snippets. The proposed system for resolving merge conflicts in a distributed blockchain framework may maintain a blockchain ledger. The blockchain ledger is a distributed data storage system comprising one or more blocks pertaining to each computing node present in the distributed blockchain framework. Each block indicates one or more code snippets and metadata associated to a developer editing the one or more code snippets.

The distributed blockchain framework may comprise a set of computing nodes communicating with each other over a secured peer to peer network. Each computing node comprises a copy of the blockchain ledger stored locally. The copy of the blockchain ledger indicates metadata about each code snippets being edited by the one or more developers over the secured peer to peer network.

The proposed system facilitates to test merge a change set programmed by one developer into a local repository of another developer working on the copy of the code snippet. In one implementation, when the test merge is conflict free at the local repository of the other developer, the change set may be pushed to a code repository comprising the software code. In another implementation, when the change set is in conflict with the copy of code snippet stored locally at the other developers' computing node, both the developers resolve the conflict by negotiating about modification of change set unless an approval is received from the other developer. Once the approval is received, the change set may be pushed into the code repository. Subsequently, a copy of the modified code snippet is shared across the set of computing nodes for further development. While aspects of described system and method for resolving merge conflict using a distributed blockchain framework including a set of computing nodes may be implemented in any number of different computing systems, environments, and/or configurations, the embodiments are described in the context of the following exemplary system.

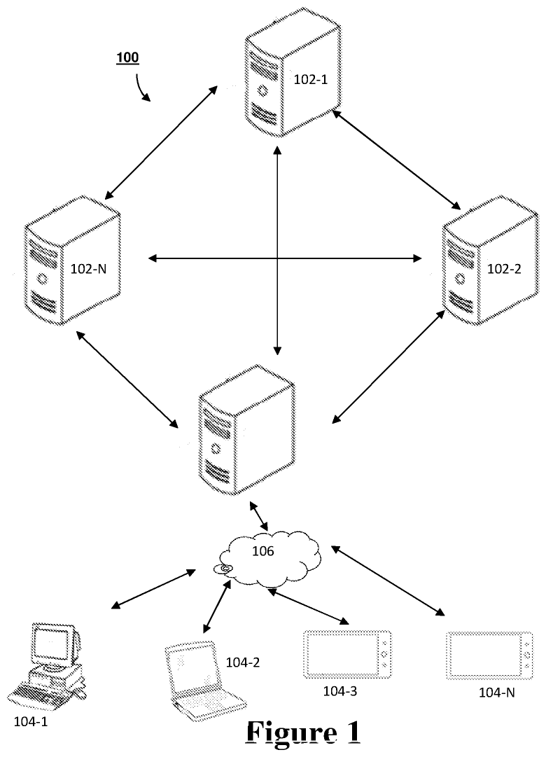

Referring now to FIG. 1, a Peer-to-Peer (P2P) network implementation 100 of a system for resolving merge conflict using a distributed blockchain framework is disclosed. The system may comprise a set of computing nodes 102-1, 102-2 . . . 102-N, collectively referred to as nodes 102 hereinafter, corresponding to the distributed blockchain framework. Each computing node 102, of the set of computing nodes, may comprise a processor and a memory coupled to the processor. The processor may execute a set of instructions stored in the memory. Initially, the computing node 102 may be configured to register a block of a code snippet, from a plurality of code snippets, in a distributed blockchain framework. The code snippet may be a subset of a software code present in a code repository. In one aspect, the block may indicate an entry marked by at least one computing node into the distributed blockchain framework.

Further, the computing node 102 may be configured to identify a subset of computing nodes comprising a copy of the code snippet. Upon identifying the subset of computing nodes, the computing node 102 may send a change set associated with the code snippet to the subset of computing nodes. In one aspect, the change set may indicate modification in the code snippet programmed by the at least one computing node. Subsequently, the computing node 102 may determine a conflict between the change set and the copy of the code snippet stored at a computing node of the subset of computing nodes. Furthermore, the computing node 102 may receive an approval from the computing node to push the change set into the code repository when the conflict is determined. It is to be noted that the approval may indicate that the conflict is resolved when the change set is executed locally by the computing node. Subsequently, the computing node 102 may be configured to push the change set into the code repository to indicate modification in the copy of code snippet stored locally in the subset of computing nodes.

Although the present disclosure is explained considering that the system is implemented on the computing node 102 in the P2P network, it may be understood that the system may be implemented in a variety of computing systems, such as a laptop computer, a desktop computer, a notebook, a workstation, a mainframe computer, a server, a network server, a cloud-based computing environment.

In one implementation, the P2P network may be a wireless network, a wired network or a combination thereof. The P2P network can be implemented as one of the different types of networks, such as intranet, local area network (LAN), wide area network (WAN), the internet, and the like. The P2P network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the P2P network may include a variety of network devices, including routers, bridges, servers, computing devices, storage devices, and the like.

It will be understood that the computing node 102 may be accessed by multiple users through one or more user devices 104-1, 104-2 . . . 104-N, collectively referred to as user 104 or stakeholders, hereinafter, or applications residing on the user devices 104. In one implementation, the computing node 102 may comprise the cloud-based computing environment in which a user may execute remotely located applications. Examples of the user devices 104 may include, but are not limited to, a portable computer, a personal digital assistant, a handheld device, and a workstation. The user devices 104 are communicatively coupled to the computing node 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

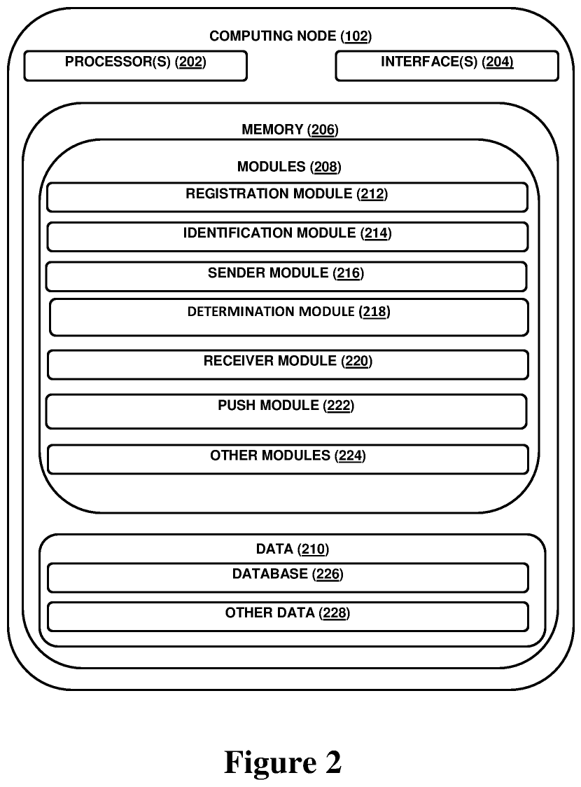

Referring now to FIG. 2, the computing node 102 is illustrated in accordance with an embodiment of the present subject matter. In one embodiment, the computing node 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the computing node 102 to interact with the user directly or through the client devices 104. Further, the I/O interface 204 may enable the computing node 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a registration module 212, an identification module 214, a sender module 216, a determination module 218, a receiver module 220, a push module 222 and other modules 224. The other modules 224 may include programs or coded instructions that supplement applications and functions of the computing node 102. The modules 208 described herein may be implemented as software modules that may be executed in the P2P network of the distributed blockchain framework including a set of computing nodes 102.

The data 210, amongst other things, serves as a repository for storing data processed, received, and generated by one or more of the modules 208. The data 210 may also include a database 226 and other data 228. The other data 228 may include data generated as a result of the execution of one or more modules in the other modules 224.

As there are various challenges observed in the existing art, the challenges necessitate the need to build the system for resolving merge conflict using a distributed blockchain framework including a set of computing nodes 102. In order to resolve merge conflict, at first, a user may use the client device 104 to access at least one computing node 102 via the I/O interface 204. The user may register them using the I/O interface 204 in order to use the at least one computing node 102. In one aspect, the user may access the I/O interface 204 of the at least one computing node 102. The at least one computing node 102 may employ the registration module 212, the identification module 214, the sender module 216, the determination module 218, the receiver module 220, and the push module 222. The detail functioning of the modules is described below with the help of figures.

The present system facilitates resolving merge conflict using a distributed blockchain framework. To do so, initially, the registration module 212 registers a block of a code snippet, of a plurality of code snippets, in a distributed blockchain framework. It is to be noted that the code snippet is a subset of a software code present in a code repository. The code snippet may also be an individual functionality present in the software code. In one embodiments, the block may indicate an entry marked by at least one computing node into the distributed blockchain framework. In an implementation, the block may comprise metadata about a developer working on the at least one computing node. The metadata may include a check out indicating a developer is editing the code snippet in a local repository.

Upon registration, the identification module 214 identifies a subset of computing nodes comprising a copy of the code snippet. The copy of the code snippet may be stored locally in each of the subset of computing nodes. It is to be noted that the subset of computing nodes may be identified by comparing metadata associated to the at least one computing node comprising the code snippet with metadata associated to the set of computing nodes.

Once the subset of computing nodes is identified, the sender module 216 sends a change set associated with the code snippet to the subset of computing nodes. The change set indicates modification in the code snippet programmed by the at least one computing node. In an embodiment, the change set may be defined as a difference between different versions of code snippets stored locally. There are two different versions of the code snippet. First version is before the code snippet is edited by the developer locally. Second version is after the code snippet is edited by the developer locally. Thus, the change set represents delta information associated to the code snippet present with the at least one of the computing node.

Subsequent to sharing the change set, the determination module 218 determines a conflict between the change set and the copy of the code snippet stored at the computing node of the subset of the computing nodes. In order to do so, the determination module 218 may locally run a test merge of the change set on the computing node. The test merge may be run locally with an uncommitted copy of the code snippet. In one implementation, if the change set is not in conflict with the uncommitted copy of the code snippet, the subset of computing nodes may issue an approval to push the change set into the code repository. In another implementation, if the change set is in conflict with the uncommitted copy of the code snippet stored at one of the computing node from the subset of computing nodes, then an approval to push the change set may not be sent to the receiver module 220. In an embodiment, developers working on both conflicting computing nodes may resolve the conflict by sharing modifications to the change set. It is to be noted that the modifications to the change set may be shared by either of the developers. In an example, the resolution may also be provided by a polling system involving all stakeholders, developers, and owners of the software code. In one implementation, the determination module 218 may determine the conflict between the change set and the copy of the code snippet based on a set of parameters. The set of parameters may include, but not limited to, parameterization of variables, memory utilization, code complexity, and platform compatibility.

The receiver module 220 receives the approval from the computing node to push the change set into the code repository when the conflict is determined. In one embodiment, the approval may indicate that the conflict is resolved when the change set is executed locally by the computing node. In another embodiment, the approval may indicate modified change set comprising modifications to the change set as agreed by the developers. In an implementation, the receiver module 220 may receive a flag indicating conflict with the change set and the uncommitted copy of the code snippet at the computing node.

Upon receipt of the approval, the push module 222 pushes the change set into the code repository to indicate modification in the copy of code snippet stored locally in the subset of computing nodes. It must be noted that the approval may be received individually from each computing node of the subset of computing node. Hence, push module 222 may not push the change set to the code repository until the approval is received from each computing node. Post pushing the change set, a modified copy of the code snippet comprising the change set is shared across the set of computing nodes present in the distributed blockchain framework.

In an embodiment, the distributed blockchain framework comprises a blockchain ledger to maintain a list of change sets programmed at the set of computing nodes. In another embodiment, the code snippet and a copy of the distributed blockchain framework are stored locally in the memory of the at least one computing node. In yet another embodiment, further to pushing the change set, a block indicating check in from the at least one computing node may be appended into the blockchain ledger.

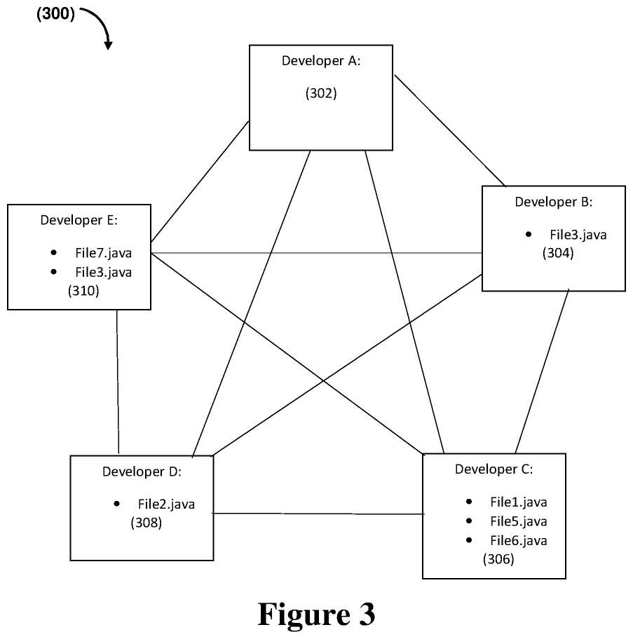

Now referring to FIG. 3, an example of the system 300 comprising 5 computing nodes is shown, in accordance with an embodiment of the present subject matter. The computing nodes 302, 304, 306, 308, and 310 are sharing a code repository in a peer-to-peer network. The code repository comprises a software code programmed in a java language. The software code comprises a set of java files comprising filet .java, file2.java, file3.java, . . . file7.java. As shown in the FIG. 3, the computing node 302 is utilized by developer A, the computing node 304 is by developer B, the computing node 306 is utilized by developer C, the computing node 308 is utilized by developer D, and the computing node 310 is utilized by developer E. Developer B is editing file3.java. Developer C is editing file1.java, file5.java, and file6.java. Developer D is editing file2.java, and developer E is editing file1.java, and file3.java.

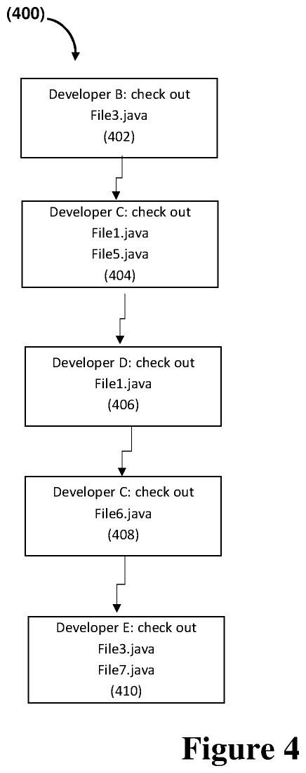

Referring now to FIG. 4 a blockchain 400 with one or more blocks pertaining to each computing node is shown, in accordance with an embodiment of the present subject matter. As shown in the figure, blocks 402, 404, 406, 408, and 410 indicates one or more files of the software code being edited (may interchangeably be referred as ‘checked out’) by the developers B, C, D, C and E respectively. It is to be noted that each transaction in the distributed blockchain framework is recorded in blocks and represented in the form of the blockchain. Any modification in the one or more files by either of the developers may be highlighted in the blockchain by amending another block.

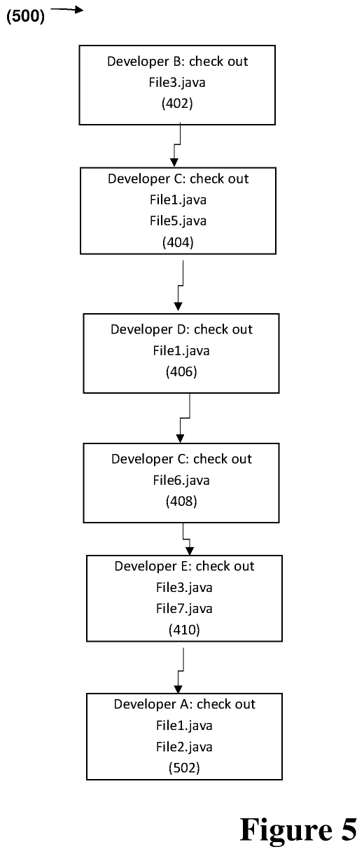

Referring now to FIG. 5, a blockchain 500 with one or more blocks pertaining to each computing node is shown, in accordance with an embodiment of the present subject matter. A block 502 may be added to the blockchain 500 indicating file1.java and file2.java being checked out by the developer A at the computing node 302. It is to be noted that each computing node may store a copy of the blockchain 500 locally. Thus, when the block 502 is added to the blockchain 500, the copy of the blockchain 500 may be updated at each computing node.

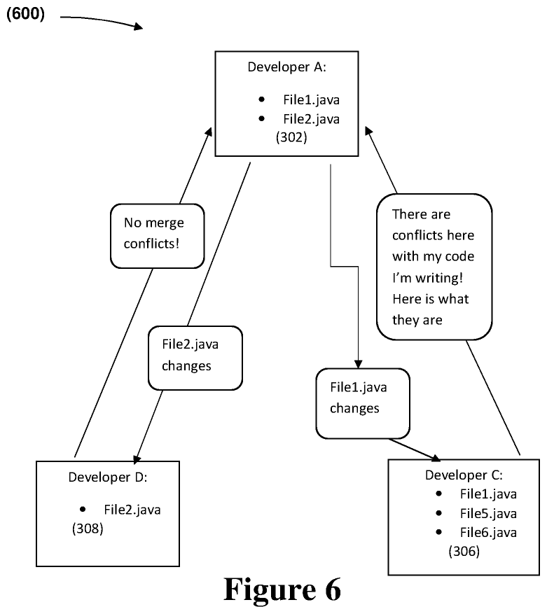

Referring now to FIG. 6, an example 600 negotiation between one or more computing nodes is shown, in accordance with an embodiment of the present subject matter. At the computing node 302, developer A has modified the file1.java and file2.java. Now, the developer A may wish to push the modified file1.java and file2.java in the code repository. However, before pushing the modified file1.java and file2.java, the system identifies the computing nodes 306 and 308 as a subset of computing nodes. The computing nodes 306 and 308 comprises file1.java and file2.java respectively. Upon identifying the subset of nodes, the computing node 302 sends first change set and second change set associated with the file1.java and file2.java to the computing nodes 306 and 308 respectively.

Upon receipt of the change set for the file2.java, the computing node 308 may commit the change set locally with the uncommitted copy of file2.java. If the change set is committed conflict free, the computing node 308 may send an approval to the computing node 302 for pushing the change set into the code repository.

At the computing node 306, the change set received for the copy of file1.java may be committed locally. Upon performing the commit operation, the computing node may send a flag to the computing node 302 indicating conflicts in the change set with the uncommitted copy of the file1.java edited locally by the developer C. As the computing node 302 receives a flag from one of the subset of computing nodes, the modified file1.java may not be pushed to the code repository. In an embodiment, developer C may suggest modification to the change set to avoid the conflict. In order to resolve the conflict with the change set of the file1.java, developer A and C may negotiate with each other over the modifications in the change set. Once the modification in the change set is approved by the developer C, the modified change set along with the file2.java may be pushed into the code repository.

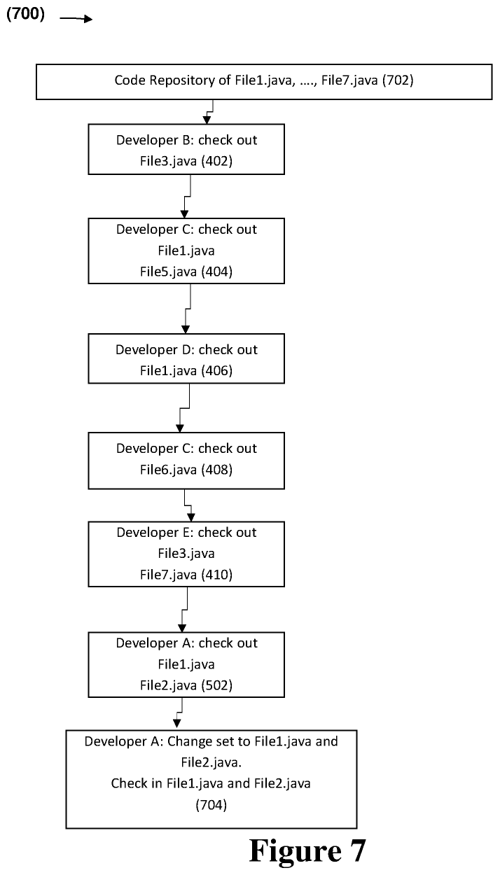

Referring now to FIG. 7, a blockchain 700 post pushing the change set to the code repository 702 is shown, in accordance with an embodiment of the present subject matter. It is to be noted that once the approval is received from the computing nodes 306 and 308, the computing node 302 pushes the modified file1.java, and the modified file2.java in to the code repository 702. Post pushing, a block 704 may be amended in the blockchain 700 indicating check in for the file1.java, and file2.java. It is to be noted that once the check in is performed by at least one computing node, the code snippet corresponding to the check in may be updated for each computing node present in the distributed blockchain framework. Further, the check in mark may not further modify the code snippet and no longer be identified as an editor node in the blockchain ledger.

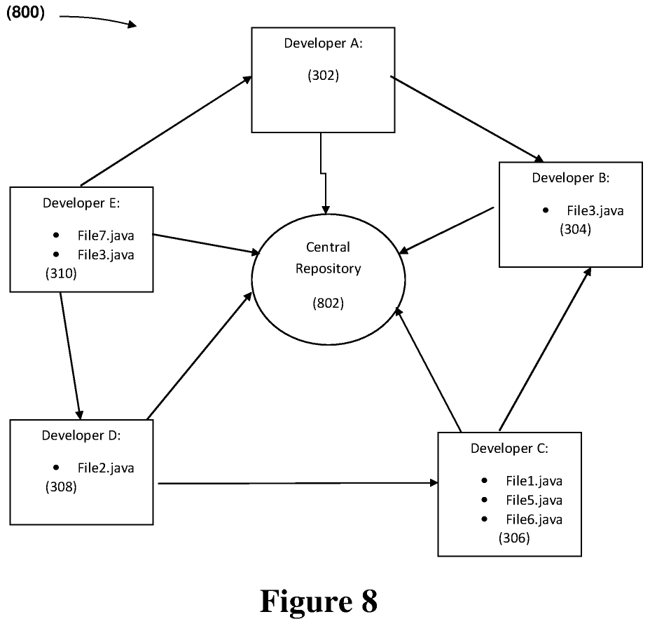

Referring now to FIG. 8 an implementation 800 of a central database 802 in the system is shown, in accordance with an embodiment of the present subject matter. In an embodiment, the central database 802 may be configured to store the blockchain ledger comprising transactional data associated to the 5 computing nodes 302, 304, 306, 308, and 310. The computing nodes 302, 304, 306, 308, and 310 may be connected to each other and the central repository 802 in a peer-to-peer network. In one aspect, the central repository 802 may receive a modified code snippet from at least one of the computing nodes. In another aspect, the central repository 802 may send the modified code snippet to a set of computing nodes connected in the distributed blockchain framework.

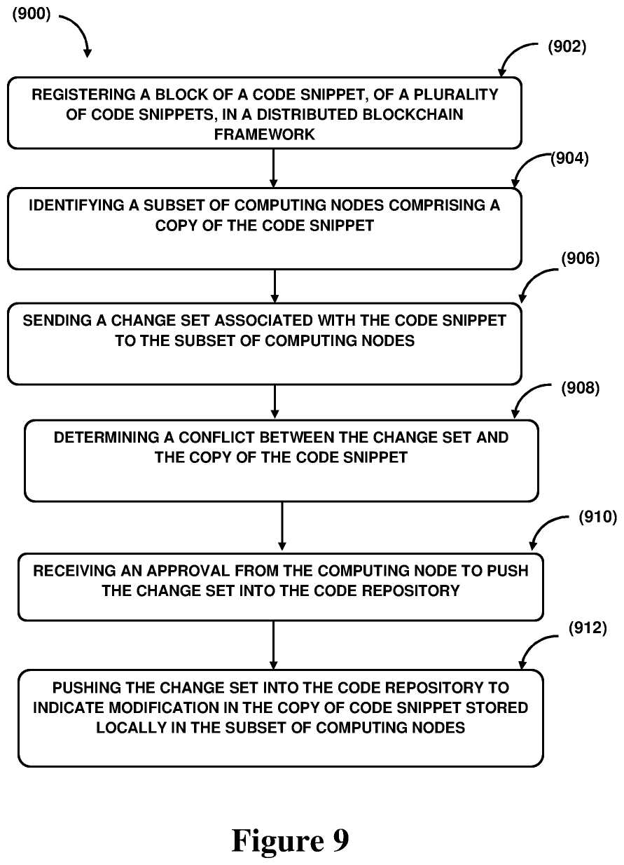

Referring now to FIG. 9, a method 900 for resolving merge conflict using a distributed blockchain framework including a set of computing nodes is shown, in accordance with an embodiment of the present subject matter. The method 900 may be described in the general context of computer executable instructions. Generally, computer executable instructions can include routines, programs, objects, components, data structures, procedures, modules, functions, etc., that perform particular functions or implement particular abstract data types. The method 900 may also be practiced in a distributed computing environment where functions are performed by remote processing devices that are linked through a communications network. In a distributed computing environment, computer executable instructions may be located in both local and remote computer storage media, including memory storage devices.

The order in which the method 900 is described is not intended to be construed as a limitation, and any number of the described method blocks can be combined in any order to implement the method 900 or alternate methods. Additionally, individual blocks may be deleted from the method 900 without departing from the spirit and scope of the subject matter described herein. Furthermore, the method can be implemented in any suitable hardware, software, firmware, or combination thereof. However, for ease of explanation, in the embodiments described below, the method 900 may be considered to be implemented as described in the computing node 102.

At block 902, a block of a code snippet, of a plurality of code snippets, may be registered in a distributed blockchain framework. In one aspect, the code snippet is a subset of a software code present in a code repository. In another aspect, the block indicates an entry marked by at least one computing node into the distributed blockchain framework. In one implementation, the block may be registered by a registration module 212.

At block 904, a subset of computing nodes comprising a copy of the code snippet may be identified from a set of computing nodes. In one implementation, the subset of computing nodes may be identified by an identification module 214.

At block 906, a change set associated with the code snippet may be sent to the subset of computing nodes. In one aspect, the change set indicates modification in the code snippet programmed by the at least one computing node. In one implementation, the change set may be sent by a sender module 216.

At block 908, a conflict may be determined between the change set and the copy of the code snippet stored at a computing node of the subset of computing nodes. In one implementation, the conflict may be determined by a determination module 218.

At block 910, an approval may be received from the computing node to push the change set into the code repository. In one aspect, the approval indicates that the conflict is resolved when the change set is executed locally by the computing node. In one implementation, the approval may be received by a receiver module 220.

At block 912, the change set may be pushed into the code repository to indicate modification in the copy of code snippet stored locally in the subset of computing nodes. In one implementation, the change set may be pushed by a push module 222.

Exemplary embodiments discussed above may provide certain advantages. Though not required to practice aspects of the disclosure, these advantages may include those provided by the following features.

Some embodiments enable a system and a method to alert users to other developers editing the same file without locking them out.

Some embodiments enable a system and a method to resolve potential conflicts among local repositories before merging the change set in the code repository.

Some embodiments allow a democratic negotiation of a merge resolution between all developers.

Some embodiments may be implemented using the same ledger a repository uses in a blockchain based version control system.

Although implementations for methods and systems for resolving merge conflict using a distributed blockchain framework including a set of computing nodes have been described in a language specific to structural features and/or methods, it is to be understood that the appended claims are not necessarily limited to the specific features or methods described. Rather, the specific features and methods are disclosed as examples of implementations for resolving merge conflict using a distributed blockchain framework including a set of computing nodes.

We claim:

1. A system configured to resolve merge conflict using a distributed blockchain framework, the system comprising:
a set of computing nodes corresponding to a distributed blockchain framework, wherein each computing node comprises:
a memory; and
a processor coupled to the memory, wherein the processor is capable of executing a set of instructions stored in the memory, and wherein the set of instructions comprises:
registering a block of a code snippet, of a plurality of code snippets, in a distributed blockchain framework, wherein the code snippet is a subset of a software code present in a code repository, and wherein the block indicates an entry marked by at least one computing node into the distributed blockchain framework;
identifying a subset of computing nodes comprising a copy of the code snippet;
sending a change set associated with the code snippet to the subset of computing nodes, wherein the change set indicates modification in the code snippet programmed by the at least one computing node;
determining a conflict between the change set and the copy of the code snippet stored at a computing node of the subset of computing nodes;
receiving an approval from the computing node to push the change set into the code repository when the conflict is determined, wherein the approval indicates that the conflict is resolved when the change set is executed locally by the computing node; and
pushing the change set into the code repository to indicate modification in the copy of code snippet stored locally in the subset of computing nodes.

2. The system of claim 1, wherein the subset of computing nodes is configured to run a test merge locally using the change set, wherein the subset of computing nodes comprises an uncommitted copy of the code snippet.

3. The system of claim 1, wherein the distributed blockchain framework comprises a blockchain ledger to maintain a list of change sets programmed at the set of computing nodes.

4. The system of claim 1, wherein the code snippet and a copy of the distributed blockchain framework are stored locally in the memory of the at least one computing node.

5. A method for resolving merge conflict using a distributed blockchain framework including a set of computing nodes, the method comprising:
registering, by a processor, a block of a code snippet, of a plurality of code snippets, in a distributed blockchain framework, wherein the code snippet is a subset of a software code present in a code repository, and wherein the block indicates an entry marked by at least one computing node into the distributed blockchain framework;
identifying, by the processor, a subset of computing nodes, from a set of computing nodes, storing a copy of the code snippet;
sending, by the processor, a change set associated with the code snippet to the subset of computing nodes, wherein the change set indicates modification in the code snippet programmed by the at least one computing node;
determining, by the processor, a conflict between the change set and the copy of the code snippet stored at a computing node of the subset of computing nodes;
receiving, by the processor, an approval from the computing node to push the change set into the code repository when the conflict is determined, wherein the approval indicates that the conflict is resolved when the change set is executed locally by the computing node; and
pushing, by the processor, the change set into the code repository to indicate modification in the copy of code snippet stored locally in the subset of computing nodes.

6. The method of claim 5, wherein the subset of computing nodes is configured to run a test merge locally using the change set, wherein the subset of computing nodes comprises an uncommitted copy of the code snippet.

7. The method of claim 5, wherein the distributed blockchain framework comprises a blockchain ledger to maintain a list of change sets programmed at the set of computing nodes.

8. The method of claim 5, wherein the code snippet and a copy of the distributed blockchain framework are stored locally in the memory of the at least one computing node.

9. A non-transitory computer readable medium embodying a program executable in a computing device for resolving merge conflict using a distributed blockchain framework including a set of computing nodes, the program comprising a program code:
a program code for registering a block of a code snippet, of a plurality of code snippets, in a distributed blockchain framework, wherein the code snippet is a subset of a software code present in a code repository, and wherein the block indicates an entry marked by at least one computing node into the distributed blockchain framework;
a program code for identifying a subset of computing nodes comprising a copy of the code snippet;
a program code for sending a change set associated with the code snippet to the subset of computing nodes, wherein the change set indicates modification in the code snippet programmed by the at least one computing node;
a program code for determining a conflict between the change set and the copy of the code snippet stored at a computing node of the subset of computing nodes;
a program code for receiving an approval from the subset of computing nodes to push the change set into the code repository when the conflict is determined, wherein the approval indicates that the conflict is resolved when the change set is executed locally by the computing node; and
a program code for pushing the change set into the code repository to indicate modification in the copy of code snippet stored locally in the subset of computing nodes.
